(19) United States
(12) Patent Application Publication
(10) Pub. No.: US 2009/0149097 A1
(43) Pub. Date: Jun. 11, 2009

(54) NANOSCALAR PARTICLES BASED ON SIO2 AND MIXED OXIDES THEREON, THEIR PREPARATION AND USE FOR TREATING TEXTILE MATERIALS

(76) Inventors: Franz Effenberger, Stuttgart (DE); Myadagmaa Rentsenlkhundev, Kelheim (DE)

Correspondence Address: Fay Sharpe LLP, 1228 Euclid Avenue, 5th Floor, The Halle Building, Cleveland, OH, 44115, US

(21) Appl. No.: 12/158,780

(22) PCT Filed: Dec. 5, 2006
(86) PCT No.: PCT/EP2006/011657

§ 371 Date: Nov. 4, 2008

(30) Foreign Application Priority Data
Dec. 23, 2005 (DE) 10 2005 062 606.8

(51) Int. Cl. D06M 10/06; B05D 5/00; D06M 11/36

(52) U.S. Cl. 442/118; 252/8.61; 977/773

(57) ABSTRACT

Nanoscale primary particles based on SiO₂ or a mixed oxide of SiO₂ and other metal oxides, especially Al₂O₃, are described. These have a mean particle size of 1 to 2000 nm (determined by the method of measuring the particle sizes with the Zetasizer NS apparatus (Nano Series)) as well as a negative charge and can advantageously be used for the hydrophilising coating of textile materials. A hydrophobic outer layer with improved alcohol and oil repellency in comparison to a textile material without a hydrophilic intermediate layer can optionally be formed here on the pretreated hydrophilic material. It is especially advantageous if the nanoscale primary particles are used for these purposes in statu nascendi in the reaction solution.

The invention relates to nanoscale primary particles based on SiO₂ or a mixed oxide of SiO₂ and other metal oxides, especially Al₂O₃, a method especially suited to producing nanoscale primary particles of this type, as well as the use thereof for the hydrophilising treatment of hydrophobic textile materials, optionally with a subsequent hydrophobing after-treatment.

The modification and exact adjustment of the surface properties of materials in general and in particular of textile materials, such as textile fibres, is of great importance for their use in various sectors. Thus, hydrophobic textile materials, such as fibres, for example, can be made wettable for water by hydrophilisation. This leads to an improved dyeing capacity of articles made of synthetic fibres, for example. This also allows better wearing comfort to be achieved. A further advantage of hydrophilisation is the reduction in the electrostatic charge. Thus, it has been known for a relatively long time, especially in the medical product sector that hydrophilic materials lead to a substantially better cell growth than hydrophobic materials.

The hydrophilisation of hydrophobic textile materials is described in the prior art. Thus, the hydrophilisation can take place by the incorporation of hydrophilic groups (such as, for example, in the polyamide fibre “Antron” from DuPont) and by the formation of a suitable yarn structure in spinning or suitable weaves in weaving. Moreover, for finishing, the possibility exists of grafting on hydrophilic groups or forming a hydrophilic film on the fibre. Moreover, so-called soil release finishes are known. In principle, three classes of compounds are used here, namely copolymers of acrylic acid or methacrylic acid, ethoxylation products of polymers, especially for synthetic fibres, or of alkylphenol derivatives, especially for cellulose fibres, as well as modified fluoropolymers, especially poly-[N-methylperfluoro-octanyl-sulphonamido-ethyl-acrylate]. When using copolymers of acrylic acid or methacrylic acid, the acid acrylates being produced have an optimal carboxyl group content with regard to the soil release efficiency. However, acid acrylates, with the same molecular weight and with the same ratio of the carboxyl group, but produced by different methods, lead to different soil release properties. In the case of ethoxylation products of polymers or of alkylphenol derivatives, a special mechanism for the physical binding of the polymers to thermoplastic materials is proposed in the prior art for the respective products. When using modified fluoropolymers, the hydrophobicity is removed by the rearrangement of the chemical groups of the polymer facing the respective medium, with the result that the outwardly effective hydrophilic groups allow soil release. In addition, the application of soil release finishes from solutions is conceivable.

In the present technical area, the application of a low-pressure plasma (1 to 100 Pa) is also significant. A low-pressure plasma can be used to functionalise the surface of textile materials in order, for example, to chemically change and hydrophilise the fibre surface. With the aid of the plasma treatment, excited neutral atoms or ions can change the surface in a thin layer in a targeted manner and therefore make it accessible to advantageous further processing. The thin layer is formed in that radicals from the plasma accumulate on the substrate surface. The layer growth begins by post-diffusion of radical particles from the plasma to the surface. The actual mechanism of the layer formation strongly depends on the parameters with which the plasma is operated. Thus, under certain conditions, for example, radicals already settle together in the gas phase and form larger molecule unions which are only deposited after the gas phase growth phase on the substrate surface. Under different conditions, the molecules are adsorbed on the surface of the substrate and only struck and excited there by the electrons. They then consequently react with the substrate. In textile technology application possibilities for low-pressure plasma treatment in a vacuum are currently being developed to improve the wettability and the dyeing capacity of chemical fibres. Hydrophobic chemical fibres are generally hydrophilised here.

It has been shown that the measures or means described above for the hydrophilisation of the surfaces of hydrophobic textile materials are not satisfactory. It has also been found that hydrophobic textile materials, which are to repel alcohol and oil, are not sufficiently hydrophobic. Consequently, the currently known methods, by which the surface of hydrophobic textile materials is configured to be hydrophilic or hydrophobic with regard to their properties, depending on the application, are not satisfactory. As a result, the present invention was based on the aim of proposing improvements here.

The above aim is addressed by nanoscale primary particles based on SiO₂ or a mixed oxide of SiO₂ and other metal oxides, especially Al₂O₃, which are characterised in that they have a mean particle size of 1 to 2000 nm (determined by the measuring method of the particle sizes with the Zetasizer NS apparatus (Nano Series)) as well as a negative charge.

The nanoscale primary particles according to the invention are distinguished by the mean particle size of about 1 to 2000 nm, it being possible for this mean particle size range to be determined by the conventional methods. In the case of the invention, the mean particle size is to be determined in dispersion by the method of measuring the particle sizes with the Zetasizer NS apparatus (Nano Series). For this purpose reference is made to the literature reference “The ultimate in desktop particle characterisation”, publisher Malvern Instruments, year of publication 2003, and “Particle Size Measurement”; T. Allen 4^{th} Edition 1992, ISBN 04123570 and 5^{th} Edition, 1997, ISBN 0412729504. For particle size determination, other comparable measuring methods may also be used, for example “Dynamic Light Scattering (DLS)” (Dr. Michael Kaszuba & Dr. Kevin Mattison “High concentration particle size measurements using dynamic light scattering” Lab Plus international—September 2004, and Dahneke B E.

“Measurement of Suspended Particles by Quasielastic Light Scattering”, 1983, Wiley). Of especial advantage for the treatment, described in detail below, of hydrophobic textile materials is a mean particle size of the nanoscale primary particles of about 40 to 500 nm, especially of about 100 to 150 nm. This applies as a rule and is not intended to be in any way restrictive as the particle size when using the nanoscale primary particles according to the invention is always matched with regard to the particular type of textile materials to be treated or the effects aimed for in that case.

According to the method described below for producing the nanoscale primary particles according to the invention, these occur, when they are isolated, in the form of a powder. They are obtained here in a conventional manner from the reaction medium, for example, by freeze drying. Agglomerate formation may also occur here. In the later use, this is generally not desired. If it should be expedient in an individual case to exclude an agglomerate formation or use the reaction means directly, this is open to the person skilled in the art. It is especially advantageous if, for the application purposes further addressed below, the nanoscale particles remain in the reaction medium and are supplied virtually in situ for the desired connection. Further statements are to be found below about the respective reaction media and reference is made thereto.

A further important characteristic of the nanoscale primary particles according to the invention is their negative charge. This is expressed as the zeta potential, determined by the measuring method of the dependency on the pH with the Zetasizer ZS apparatus. This is known to the person skilled in the art. In this regard, reference is made to the general literature “Zetapotential und Partikelladung in der Laborpraxis” by Rainer H. Muller, 1996 and “Electrophoresis of particles in suspension, in Surface and Colloid Science”, James, A. M., Plenum Press, New York 1979. Basically, the zeta potential may also be determined, however, by other known specialised methods, for example M3 (Mixed Mode Measurement) technique, described in the literature reference M.

Minor., A. J. van der Linde “Dynamic aspects of Electrophoresis and Electro-osmosis: A new fast method for measuring particle mobilities”, Journal of Colloid and Interface Science, 189 (1997) and Hunter, R. J., “Zeta Potential in Colloid Science”, Academic Press, London 1981.

The zeta potential in the scope of the invention preferably lies at about −10 to −200 mV, especially between about −10 to −100 mV. The preferred negative charge may also depend on the chemical type of the nanoscale primary particles according to the invention, i.e. in the case of nanoscale primary particles on the sole basis of SiO₂, this may be different than in the case of a mixed oxide of SiO₂ and other metal oxides, especially Al₂O₃. It is preferred for nanoscale primary particles based on SiO₂/Al₂O₃ to have a zeta potential of about −8 to −100 mV, especially of about −10 to −40 mV. Nanoscale primary particles based on SiO₂ preferably have a negative charge of about −100 to −200 mV, especially of about −100 to −150 mV, especially about −100 mV. The negative charge is preferably determined here with the Zetasizer apparatus by the measuring method of dependency on the pH.

In the scope of the invention, nanoscale primary particles solely based on SiO₂ are especially advantageous. Nevertheless, it has been shown that mixed oxides of SiO₂ with other metal oxides, especially Al₂O₃ can also be especially advantageous in various applications. As an advantageous rule, in the scope of the invention in the nanoscale primary particles based on SiO₂ and other metal oxides, it can be stated that about 0.125 to 0.625 parts by weight, especially about 0.125 to 0.25 parts by weight of the further metal oxide are apportioned to one part by weight SiO₂. In the case of the mixed oxide of SiO₂ and Al₂O₃, it has proved to be particularly advantageous if this has a —Si—O—Al— network and a solid body NMR spectrum with Q groups [Q⁴(2 Al)] and [Q⁴(1 Al)].

The subject of the invention is moreover an advantageous method for producing the above-described nanoscale primary particles according to the invention. In the production of nanoscale primary particles, which are substantially based on silicon dioxide, the dispersion of an orthosilicate, in particular in the form of tetramethylorthosilicate (TMOS) in the presence of a dispersing agent, especially non-ionic dispersing agent, is preferably stirred with a high-power stirrer and the orthosilicate is hydrolysed into nanoscale primary particles. This method is modified if a mixed oxide of SiO₂ with other metal oxides is to be converted into nanoscale primary particles. The procedure is preferably such here that the in particular aqueous solution or dispersion of a metal salt is in particular mixed into the aqueous dispersion or solution of the orthosilicate to form a mixed oxide of SiO₂ and other metal oxides and this aqueous mixture is then stirred with the high-power stirrer and the orthosilicate contained therein is hydrolysed into nanoscale primary particles. Non-ionic dispersing agents are preferred. Alcohol ethoxylates in the form of the commercial product Tissocyl RLB can be given as particular examples, wherein the homogeneity of the dispersion or the solution of the orthosilicate is to be encouraged, especially. The quantity of the dispersing agent is adjusted in a specialist manner. In general, the quantity of dispersing agent is in a range from about 0.2 g/l to 2 g/l, especially from about 0.4 g/l to 0.8 g/l.

The method according to the invention can be carried out at room temperature or about 20° C., but also at an elevated temperature, for example up to about 40° C. Suitable hydrolysis conditions have to be adjusted in the reaction medium in which the nanoscale primary particles accumulate. This may take place, for example, by including a suitable catalyst. These may be diluted acids, in particular dilute hydrochloric acid. The preferred concentration range of the dilute hydrochloric acid in the dispersion to be subjected to the hydrolysis is between about 0.5 to 0.001 N, especially between about 0.008 and 0.015 N.

The abstract teaching of the method shown above may be configured in many ways: it has thus been shown to be particularly advantageous if a high-power stirrer with high shearing powers is used, for example an Ultra-Turrax apparatus (marketed by the company Janke & Kunkel GmbH). The especial advantages of a high-power stirrer of this constructions are that the reaction medium can be completely homogenised. It has surprisingly been shown that the particle size of the nanoscale primary particles can be controlled in many ways in that the individual parameters of the abstract teaching of the method according to the invention are modified. The method according to the invention thus offers the especial advantage that it can easily be controlled with regard to the aimed for mean particle size of the nanoscale primary particles which is desirable in the individual case. Thus, the mean particle size may be desirably controlled by a variation in the concentration of the orthosilicate, especially the tetramethylorthosilicate, the concentration of the metal salts used to form mixed oxides, the concentration of the solvent of the reaction means and by the choice of the solvent, although water always has to be added to initiate the hydrolysis. The aqueous medium may in this case contain, for continuing control, as shown in detail below, various other organic solvents, especially alcohols, such as methanol and/or ethanol, especially.

An especially advantageous control consequently lies in the selection of the respective solvent or dispersion means, which consequently form the liquid phase of the reaction medium. If, for example, only water is used, in the inventive framework of a particle size of 1 to 2000 nm, a raised mean particle size of, for example, 40 to 500 nm can be adjusted. If alcohol, especially in the form of methanol and/or ethanol is used as the dispersion means, the mean particle size can be greatly lowered, for example into the range of about 1 to 500 nm, especially about 1 to 10 nm. Mean values can be achieved especially by adjusted mixing of the alcohols mentioned with water. An especially advantageous possibility of control is to vary the concentration of the orthosilicate, especially tetramethylorthosilicate in the dispersion to be subjected to hydrolysis. The concentration range of about 0.5 to 5% by weight, especially from about 0.5 to 2% by weight, is especially advantageous to adjust the desirable low mean particle size of 40 to 500 nm, especially of 100 to 150 nm.

A further control possibility in conjunction with nanoscale primary particles based on SiO₂/Al₂O₃ is to adjust the concentration of the aluminium salt in the dispersion to be subjected to hydrolysis in a targeted manner. It is especially advantageous here for the reaction medium to be subjected to the hydrolysis to contain the aluminium salt, especially the aluminium sulphate in a quantity of 10 to 30 mol %, especially 15 to 25 mol %, based on the quantity of the orthosilicate. Basically, the respective starting dispersion of the aluminium salt can also be ready adjusted with regard to this requirement.

When hydrolysis was referred to above, as the practical application of the invention shows, this does not have to be completed. In individual cases it is adequate in order to achieve the desirable effects for it to be partially completed to show, for example, nanoscale particles based on SiO₂ or SiO₂/Al₂O₃ in a particle size of about 80 to 120, especially about 95 to 105 nm, which are advantageous for application in textile finishing.

With the teaching of the method according to the invention, any desired particle sizes may thus be produced in the range mentioned of 1 to 2000 nm. The various sizes, which may be varied here for control, have already been mentioned above. The particular selection of the solvent and the adjustment of the particular pH is significant here, especially. The pH should generally be between about 3 to 5, especially between about 4.5 to 5.

The especial value of the nanoscale primary particles according to the invention is that hydrophilic textile materials can be coated therewith in a hydrophilising manner, especially simply. This coating can be carried out in a simple form. Thus, the nanoscale primary particles are introduced in a reduction medium (water, alcohol and/or especially a mixture of water/alcohol). The concentration of TMOS in the application dispersion is not critical. It should advantageously be between about 0.5 to 5% by weight, especially between about 0.5 and 2% by weight. This is independent of the non-critical concentration of the application dispersion. On nanoscale primary particles, this is introduced onto the textile material to be treated or the textile material is impregnated therewith. A squeezing off follows, and this can take place with a foulard. For example, a squeezing off may take place here at 0.15 kp/cm² pressure and at a speed of about 1 m/min. Drying follows, which may take place, for example, in a conventional drying cabinet for 20 minutes at 80° C.

The textile materials to be used in the scope of the use teaching according to the invention are diverse. These may in this case be filaments, fibres, yarns, woven fabrics, knitted fabrics and/or nonwovens, which are provided with a hydrophilic coating. The textile materials may, for example, comprise of polymeric materials or glass materials. If they are present in the form of organic polymers, these are preferably polyesters, polyolefins, especially homopolymers or copolymers of ethylene and/or propylene, halogenated polyolefins, especially PVC, polyacrylic acid derivates (PAN) and polyamides. These textile materials receive a pronounced hydrophilicity owing to the treatment according to the invention. This can be confirmed by various measuring methods such as with the aid of the measuring method of the contact angle of a water drop and the liquid strike through time test. Thus, the especially advantage is shown on a hydrophilised nonwoven made of polypropylene, in which the contact angle, in comparison to the non-hydrophilised nonwoven, is reduced from 120° to 60°. In a polypropylene woven fabric, a reduction took place from 117° to 48°. The especial degree of hydrophilicity is shown on a polypropylene nonwoven, in which it can be measured that in a liquid strike through time test, the hydrophilised polypropylene nonwoven is wetted by the test liquid after less than 3 seconds.

The formation of a hydrophilic coating is easily possible with a purely specialist procedure. In this case, as already mentioned above, the reaction medium is preferably used directly after production of the nanoscale particles as it were in the in situ state. It is surprising here that the hydrophilising coating can be configured to be extremely thin, for example in the thickness of the particle diameter. The hydrophilising is then completely sufficient. The hydrophilised material can be adapted well. For example, in the case of use of babies' nappies, a super absorber, virtually in a package, is incorporated in a hydrophilised material of this type. The coating which is now carried out, in the case of polypropylene, for example, has the advantage, that it feels good on the skin, that it absorbs moisture and discharges it again well to the outside through the propylene. Although the hydrophilic coating can absorb some moisture, it discharges it again immediately. Thus, the so-called “super absorber” is situated inside the nappy. The same applies to panty inserts and the like. The implementation of the invention is also of especial advantage in sports clothing. A pleasant feeling is also conveyed to the wearer here, with the perspired moisture, as desired, not being built up, but discharged to the outside. Accordingly, owing to the above-described hydrophilising coating of hydrophobic textile materials, products are obtained, which are of especial value in the sport, medicine and hygiene sectors.

It has been surprisingly shown that the hydrophobic textile materials provided in the above manner with a hydrophilic coating are accessible to diverse advantageous further uses. Thus, there are textile materials which have to have an increased hydrophobicity. This is firstly achieved in that, for example, fluorinated hydrocarbons are applied to the hydrophobic textile materials. These materials are comparatively expensive and do not lead to the desired high degree of hydrophobing. It has surprisingly been shown that if hydrophobic textile materials are hydrophilised according to the invention and the known hydrophobic coating is applied to the hydrophilic intermediate layer, especially advantageous properties are adjusted. These improvements with regard to the alcohol and oil repellency are adjusted in comparison to textile materials of the type in which no hydrophilic intermediate layer is present. Moreover, the quantity of expensive hydrophobing material can be significantly reduced without the effects achieved being impaired. This applies in particular to fluorinated compounds, especially fluorocarbon resins, in which the application quantity of fluorinated compounds can be significantly reduced. The application of the hydrophobing layer takes place in a specialist manner. Consequently a two step method is carried out here, i.e. the hydrophilisation is firstly carried out in the manner described and the hydrophobic coating is applied thereon. Details with regard to the hydrophobing of textile materials emerge from the following examples. As a result particularly advantageous hydrophobised textile materials are obtained by a chemical hydrophobing after-treatment, for example with fluorocarbon resin, which materials exhibit the effects mentioned of alcohol and oil repellency, but also dirt repellency. These effects show dependency on the particle size of the nanoscale primary particles, which emerges from the following FIG. 1.

An especially advantageous use of the nanoscale primary particles according to the invention is that an antimicrobial finish is implemented on the hydrophilic coating, referred to above, of the textile materials. This is an antibactericidal finish, especially, even if basically an antifungicidal finish can also be considered, for example, if it makes sense. It is preferred if the antimicrobial finish is achieved by cationic compounds, in particular by quaternary ammonium salts, especially by benzalkonium chloride (alkylbenzyldimethylammonium chloride), wherein as the quaternary ammonium salt with a long alkyl chain, one such is preferred which has 12 to 18 carbon atoms in the alkyl chain. The use of antimicrobial substances in the form of polyhexamethylenebiguanidylimide or chitosan, especially in the form of water-soluble chitosan oligomers is of especial advantage.

As a result, the invention is connected with diverse advantages, which have already been dealt with above. Moreover, the hydrophilised materials according to the invention show an improvement with regard to the dyeing capacity, the wearing comfort and soilability. Furthermore, the electrostatic charge is advantageously reduced.

The invention will be described in more detail below with the aid of examples. These are examples for producing the nanoscale primary particles according to the invention and examples, according to which textile materials are hydrophilised as well as hydrophilised and then made hydrophobic.

### EXAMPLE 1

### Production of Nanoscale Particles

1% by weight TMOS (tetramethylorthosilicate) is added to distilled water. With regard to the later use, the quantity of TMOS is dependent on the weight and on the liquor pick-up of the textile material to achieve optimal effects. A drop of a non-ionic dispersing agent (chemical name: fatty alcohol ethoxylate; commercial product Tissocyl RLB, marketed by the company Zschimmer & Schwarz) is added to the dispersion obtained, to obtain a homogeneous dispersion and to obtain a small nanoscale primary particles. Thereupon, 20 mol % aluminium sulphate based on the quantity of orthosilicate used are added to distilled water. Of the initially obtained dispersion, which was produced using TMOS, 0.125 parts by weight were mixed with 0.625 parts by weight of the second dispersion. This took place in a high-power dispersing apparatus with the commercial name Ultra-Turrax, marketed by the company Janke & Kunkel GmbH. The mixing process lasted about 20 seconds.

The dispersion produced was measured with a Zetasizer N.S. to investigate the particle size distribution. The dispersion was stable for 24 hours. The average mean particle size of the mixed oxide SiO₂/Al₂O₃ was about 120 nm. Of the aqueous dispersion, two drops were placed on a glass carrier. Drying at room temperature followed for 120 h. SEM investigations were then carried out. In this case, spherical, also partially agglomerated particles in the range of 500 nm were determined. The average particle size was 120 nm.

It was determined with the aid of further tests that the particle size can be controlled in the range from 10 nm to 2 μm, which depends on the concentration of the TMOS, but also on the respectively selected solvent. If an alcohol in the form of methanol and/or ethanol is used, with the same conduct of the method as above, a mean particle size of the primary particles of 1 to 10 nm can be adjusted, while at a concentration of TMOS of more than 3% by weight, the particles were in a micrometre range of 1 to 2 μm. After 6 hours the dispersion transformed into a viscous gel.

A further test was carried out with ethanol (100%) as the dispersing agent. 6% by weight TMOS were mixed here with vigorous stirring in an Ultra-Turrax apparatus until a homogeneous mixture developed. 10 ml 0.01 NHCl (as the catalyst) were then added dropwise. Stirring again took place vigorously for one hour. The alcoholic dispersion obtained was stable in the long term and at room temperature showed no change of any kind after 30 days. The mean particle size was about 10 nm. The size distribution was uniform.

It can be shown by means of various production methods that the dispersion produced from 1% by weight TMOS, based on this 20 mol % aluminium sulphate, and 1 to 2 drops of non-ionic dispersing agent, leads to the formation of nanoscale particles (about 100 nm) in a uniform size distribution and with a stability of 1 day and more. The alcoholic and/or aqueous dispersions were weakly acidic, in particular they were in the pH range of 4.5 to 5.0. They were measured with the “Zetasizer” apparatus (marketed by the company Malvern Instruments) with regard to the zeta potential to determine the charge state of the primary particles. It turned out in this case that the nanoscale primary particles, produced from 1% by weight TMOS, based on this 20 mol % sulphate, and 1 to 2 drops of non-ionic dispersing agent, have a negative charge.

If one of the dispersions designated above was freeze dried at −50° C. for 24 hours, a white and fine powder accumulated. In order to investigate, in the case of the mixed oxide SiO₂/Al₂O₃, the respective binding ratio of the nanoscale primary particles, these were analysed by means of solid body NMR spectroscopy. The investigation results show that the hydrolysis of TMOS and aluminium sulphate leads to a —Si—O—Al— network, which is formed by so-called Q groups [Q⁴(2 Al) and Q⁴(1 Al)].

Previous investigation results show that nanoscale particles based on SiO₂ or SiO₂/Al₂O₃ with a particle size of 100 nm are particularly suitable in the coating of textile materials. If the particle size is below 100 nm, in individual cases, no repellency effects may occur. An AFM image shows that the nanoscale particles sink on a rough fibre surface (deep holes). This is expressed in FIG. 4 which follows below. If the nanoscale particles have a diameter of more than 500 nm, the textiles exhibit a hard feel, which could be disturbing, but does not have to be in individual cases.

### Investigation of the Nanoscale Particles SiO₂ or SiO₂/Al₂O₃ (About 100 nm)

### 1. Zeta Potential Measurement

An aqueous dispersion (weakly acidic pH=4.5 -5.0) with a concentration of 0.5 to 2% by weight TMOS and 10 to 30 mol % Al₂(SO₄)₃, based on the quantity of TMOS, in addition 0.2 g/l to 0.8 g/l non-ionic dispersing agent, was measured with the Zetasizer ZS apparatus from the company “Malvern Instruments”. The zeta potential was calculated to determine the charge state of the nanoscale primary particles. The result shows that the nanoscale particles have a negative charge of −8 mV and the SiO₂-containing dispersion without the addition of aluminium sulphate has a negative charge of −100 mV. Literature values are compiled in the following table:

TABLE 1
(Zeta potential according to Kanamari)

| Fibre | Zeta potential [mV] |
|---|---|
| CO | 54.00-30.20 |
| CO, mer. | 74.00-24.40 |
| CV | 16.60-3.20 |
| PAN | 59.9-23.46 |
| PES | 81.52-58.20 |
| PVC | 48.00-51.40 |
| Glass fibre | 41.10-35.19 |

Note:
values from (H. F. Rouette “Lexikon für Textilveredelung”, Springer-Verlag Berlin, year of publication 1995, pages 2670 to 2671).

### 2. Solid Body NMR Spectroscopy

The dispersion described above was freeze dried here at −55° C. for 24 hours. A white, fine powder was obtained. In order to investigate the binding ratio of nanoscale particles, these were analysed by means of solid body NMR spectroscopy. The investigation results show that the hydrolysis of TMOS of aluminium sulphate leads to a —Si—O—Al— network, which can be described by Q groups [Q⁴(2 Al)] and [Q⁴(1 Al)].

### EXAMPLE 2

### Hydrophilisation of Textile Materials

Dispersions containing SiO₂ or SiO₂/Al₂O₃ (particle size: 100 nm) were coated on different textile materials on the foulard as follows and hydrophilised:

A dispersion of SiO₂ or SiO₂/Al₂O₃ was firstly produced in a concentration of 0.5 to 2% by weight. The textile material was impregnated with this dispersion at room temperature (20° C.). A squeezing out followed at 0.15 kp/cm² pressure and 1 m/min speed on the foulard. Drying at 80° C. in a drying cabinet for 20 minutes followed.

After the hydrophilisation of the textile materials, which will be described below, a contact angle measurement and a liquid strike through time test were carried out. The results investigated show that textile materials coated with nanoscale particles (SiO₂ or SiO₂/Al₂O₃) have very good hydrophilic properties.

The contact angle measurement was carried out with the FIBRO DAT apparatus (Dynamic Adsorption and Contact Angle Tester). The results of the contact angle measurement are compiled in the following Table 2.

TABLE 2
(Contact angle measurement)

| | Contact angle [°] | | |
|---|---|---|---|
| | after | after | after |
| Textile material | 0.1 sec | 0.5 s | 10 s |

PP nonwoven (52 g/m²)

| | | | |
|---|---|---|---|
| Untreated | 128.1 | 127.1 | 125.4 |
| Plasma treated (O₂; 80 Pa.; 60 sec) | 120.6 | 120.4 | 120.1 |
| SiO₂ particles (about 100 nm) | 114.4 | 80.8 | —* |
| SiO₂/Al₂O₃ particles (about 100 nm) | 106.6 | 80.1 | —* |

PP woven fabric (128 g/m²)

| | | | |
|---|---|---|---|
| Untreated | 117.8 | 118.0 | 117.9 |
| Plasma treated (O₂; 80 Pa.; 60 sec) | 88.8 | 87.6 | 86.3 |
| SiO₂ particles (about 100 nm) | 106.4 | 105.8 | 50.2 |
| SiO₂/Al₂O₃ particles (about 100 nm) | 108.0 | 107.6 | 48.8 |

PES woven fabric (106 g/m²)

| | | | |
|---|---|---|---|
| Untreated | 78.7 | 62.9 | 46.8 |
| SiO₂ particles (about 100 nm) | 67.4 | 43.5 | —* |
| SiO₂/Al₂O₃ particles (about 100 nm) | 60.6 | 53.6 | —* |

Note:
*complete wetting

Reference is made to the fact that the hydrophilic properties of the coated textile material are all the better, the smaller the contact angle.

Investigation results of the liquid strike through time test: a polypropylene nonwoven (20 g/m²) and a polypropylene nonwoven (52 g/m²) (both conventional commercial nonwovens) were coated with nanoscale particles (SiO₂ or SiO₂/Al₂O₃) to test the hydrophilic properties. The liquid strike through time test was also carried in accordance with CEL Norm 014 (based on ISO 9073-8). With regard to the feature “permanently hydrophilic”, the following requirement profile was taken as a basis: 1^{st} Strike<3 s: wetting of the hydrophilised textile materials within 3 s means very good hydrophilicity; 2^{nd} Strike<5 s: very good hydrophilicity; 3^{rd}-5^{th} Strike<5 s very good hydrophilicity (process of the 2^{nd} Strike is repeated without changing the filter papers).

TABLE 3
(Liquid Strike Through Time Test)

| | | | | | |
|---|---|---|---|---|---|
| 1^{st} strike | 2^{nd} strike | 3^{rd} strike | 4^{th} strike | 5^{th} strike | |
| through | through | through | through | through | |
| [sec] | [sec] | [sec] | [sec] | [sec] | rewet (g) |

20 g/m² PP nonwoven coated with SiO₂

| | | | | | |
|---|---|---|---|---|---|
| — | 2.08 | 3.21 | 3.21 | 3.01 | 1.42 |
| 1.41 | 2.56 | 2.35 | 2.50 | 2.78 | 4.53 |
| 1.37 | 2.45 | 2.50 | 2.45 | 2.52 | 0.89 |
| 1.32 | 2.55 | 2.53 | 2.47 | 2.38 | 1.27 |
| 1.45 | 2.70 | 2.83 | 2.73 | 2.24 | 1.34 |
| 1.39 | 2.42 | 2.50 | 2.26 | 2.28 | 1.28 |
| 1.39 | 2.57 | 2.55 | 2.54 | 2.48 | 1.24 |

20 g/m² PP nonwoven coated with SiO₂/Al₂O₃

| | | | | | |
|---|---|---|---|---|---|
| 1.61 | 2.95 | 2.87 | 2.82 | 2.87 | 0.60 |
| 1.74 | 2.82 | 3.00 | 2.72 | 3.01 | 0.55 |
| 1.64 | 2.47 | 2.83 | 4.46 | 2.52 | 1.01 |
| 1.67 | 2.62 | 2.88 | 2.62 | 2.90 | 1.19 |
| 1.59 | 2.57 | 2.66 | 2.90 | 2.71 | 1.07 |
| 2.12 | 3.33 | 3.29 | 3.11 | 2.82 | 1.73 |
| 1.73 | 2.79 | 2.92 | 2.77 | 2.81 | 1.03 |

The investigation results using the liquid strike through time test show that polypropylene nonwovens (20 g/m²) coated with nanoscale particles (SiO₂ or SiO₂/Al₂O₃) have a 1^{st} liquid strike through of less than 3 s.

TABLE 4
(Liquid Strike Through Time Test)

| | | | | | |
|---|---|---|---|---|---|
| 1^{st} strike | 2^{nd} strike | 3^{rd} strike | 4^{th} strike | 5^{th} strike | |
| through | through | through | through | through | |
| [sec] | [sec] | [sec] | [sec] | [sec] | rewet (g) |

52 g/m² PP nonwoven coated with SiO₂

| | | | | | |
|---|---|---|---|---|---|
| 4.18 | 4.21 | 4.54 | 4.17 | 3.58 | 2.00 |
| 4.37 | 4.10 | 3.98 | 3.14 | 2.94 | 2.50 |
| 4.72 | 3.66 | 3.94 | 3.26 | 2.79 | 2.48 |
| 4.76 | 4.07 | 3.60 | 3.23 | 3.12 | 2.33 |
| 5.05 | 4.21 | 3.99 | 3.56 | 3.22 | 2.83 |
| 4.62 | 4.05 | 4.01 | 3.47 | 3.13 | 2.43 |

52 g/m² PP nonwoven coated with SiO₂/Al₂O₃

| | | | | | |
|---|---|---|---|---|---|
| 4.08 | 5.07 | 4.39 | 3.94 | 3.34 | 4.75 |
| 3.27 | 3.93 | 4.09 | 3.32 | 2.88 | 3.12 |
| 2.87 | 3.89 | 3.74 | 3.15 | 2.58 | 3.11 |
| 3.69 | 4.30 | 4.28 | 3.69 | 3.02 | 2.69 |
| 3.28 | 4.13 | 3.82 | 3.64 | 3.09 | 2.32 |
| 3.44 | 4.26 | 4.06 | 3.55 | 2.98 | 3.20 |

Although the polypropylene nonwoven (52 g/m²) was thick, the textile material is wetted within 5 s at the 2^{nd} liquid strike through and 3^{rd} liquid strike through.

Finally, a polypropylene nonwoven (16 g/m²), was coated nanoscale particles (SiO₂ or SiO₂/Al₂O₃) to test the hydrophilic properties. For this purpose, a liquid strike through time test was carried out again in accordance with CEL Norm 014 (based on ISO 9073-8). A desirably high hydrophilicity was also exhibited here.

### EXAMPLE 3

### Hydrophobing of Textile Materials

This is a combined coating of textile materials with nanoscale particles (SiO₂ or SiO₂/Al₂O₃) and a subsequent hydrophobing chemical after-treatment of the material. Accordingly, a hydrophilising coating was firstly formed on the surface of the textile material. It is subsequently shown that much smaller quantities of hydrophobing agents and especially fluorocarbon resins are required. The hydrophobing preferably takes place by a two-step method. Accordingly, the nanoscale particles were produced first (SiO₂ or SiO₂/Al₂O₃ with a particle size of about 100 nm), then applied and dried at 80° C. for 20 min. A conventional commercial fluorocarbon resin was then applied as follows to the textile materials with the foulard. The textile hydrophilised material was impregnated with a dispersion which has the following composition: 0.5-2% by weight TMOS; 10 to 30 mol % aluminium sulphate, based on the quantity of TMOS, and 0.2 g/l to 0.4 g/l of non-ionic dispersing agent.

A squeezing off at 0.35 kp/cm² pressure and a speed of 1 m/min on the foulard followed. Drying at 130° C. for 3 minutes in the drying cabinet followed.

The investigation results shown below show that 10 g/l fluorocarbon resin (30% active content of fluorine) on a polyester (PES woven fabric) and 17 g/l fluorocarbon resin (30% active content of fluorine) on polypropylene nonwoven/woven fabric are adequate as the fluorocarbon resin addition in order, in combination with the nanoscale particles according to the invention (SiO₂ or SiO₂/Al₂O₃ with a particle size of about 100 nm), to achieve very good hydrophobic and oleophobic properties. The textile materials treated with the two step methods show that the contact angle with a polyester (PES) woven fabric (103 g/m²) is increased from 43.50 to 128° and in a polypropylene (PP) nonwoven (52 g/m²) is increased from 88° to 130°.

In the scope of the invention, the zeta potential measurement of the charge state of the nanoscale particles is significant. Thus, measurements showed that the nanoscale primary particles according to the invention have a charge, for example, of −100 mV in conjunction with SiO₂ and −8 mV in conjunction with SiO₂/Al₂O₃, while the particles of the fluorocarbon resin dispersion are positively charged. Reference is made in this regard to the accompanying FIG. 4. The combination of positively charged textile material, the application of negatively charged and again positively charged fluorocarbon resin materials allows very good adhesion to be achieved and leads to a good effect of repellency against water, oil, dirt and alcohol. The corresponding data are compiled in the following Table 5.

With regard to FIG. 2, the following is also to be stated: the investigation results which emerge from this go back to an investigation of a commercial institute. There are deep holes on an uncoated fibre surface. After the coating with nanoscale particles, the deep holes are covered and a finely structured fibre surface forms (two different fibre surfaces a and b).

TABLE 5
(Alcohol and oil repellency test)

| | | |
|---|---|---|
| | Alcohol repellency | Oil repellency |
| | test to | test to DIN |
| Nonwoven sample | IST 80.1 (01) | EN ISO 14419 |

52 g/m² conventional commercial PP nonwoven

| | | |
|---|---|---|
| firstly coated with SiO₂, | 10 | 8 |
| then FC (17 g/l)* | (very good) | (very good) |
| firstly coated with | 10 | 8 |
| SiO₂/Al₂O₃, then FC (17 g/l) | (very good) | (very good) |
| coated only with FC (17 g/l) | 2 | 1 |
| | (very poor) | (very poor) |
| firstly coated with SiO₂, | 10 | 6 |
| then 6% Rucostar** | (very good) | (satisfactory) |
| firstly coated with | 10 | 6 |
| SiO₂/Al₂O₃, then 6% | (very good) | (satisfactory) |
| Rucostar | | |
| coated only with 6% | 4-5 | 1 |
| Rucostar | (adequate) | (very poor) |
| firstly coated with SiO₂, | 8-9 | 4-6 |
| then 2% Rucoguard*** | (good) | (adequate) |
| firstly coated with | 8-9 | 4-6 |
| SiO₂/Al₂O₃, then 2% | (good) | (adequate) |
| Rucoguard | | |
| coated only with 2% | 4 | 1 |
| Rucoguard | (adequate) | (very poor) |

20 g/m² conventional commercial PP nonwoven

| | | |
|---|---|---|
| firstly coated with SiO₂, then | 10 | 8 |
| 17 g/l FC | (very good) | (very good) |
| firstly coated with | 10 | 8 |
| SiO₂/Al₂O₃, then 17 g/l FC | (very good) | (very good) |
| coated only with FC (17 g/l) | 6 | 1 |
| | (satisfactory) | (very poor) |

16 g/m² conventional commercial PP spunbonded nonwoven

| | | |
|---|---|---|
| firstly coated with SiO₂, then | 10 | 8 |
| 7 g/l FC | (very good) | (very good) |
| firstly coated with | 10 | 8 |
| SiO₂/Al₂O₃, then 7 g/l FC | (very good) | (very good) |
| coated only with 7 g/l FC | 8 | 1 |
| | (medium) | (very poor) |

Notes:
*conventional commercial fluorocarbon resin dispersion (30% active content)
**fluorocarbon resin with polymeric, highly branched dendrimers in a hydrocarbon matrix, cation-active
***fluorocarbon polymer, cation-active

Further tests were carried out with regard to the hydrophobing: two PP nonwovens (20 g/m² and 52 g/m²) were firstly coated with nanoscale SiO₂ or SiO₂/Al₂O₃ particles and then with FC to test the hydrophobic properties. The water column test was carried out here with the water tightness test apparatus from TEXTEST (based on EDEANA 120.1-80) and oil and alcohol repellency tests were carried out.

TABLE 6
(Water column with the water tightness test apparatus from TEXTEST)
(20 g/m² PP nonwoven)

| firstly coated | firstly coated | coated only |
|---|---|---|
| with SiO₂, | with SiO₂/Al₂O₃, | with 17 g/l |
| then 17 g/l FC | then 17 g/l FC | FC |
| 5.0 (mbar) | 6.0 (mbar) | 7.5 (mbar) |
| 5.0 (mbar) | 6.5 (mbar) | 5.0 (mbar) |
| 6.0 (mbar) | 6.5 (mbar) | 6.0 (mbar) |
| 6.0 (mbar) | 6.5 (mbar) | 5.0 (mbar) |
| — | 6.5 (mbar) | 6.0 (mbar) |
| — | 5.5 (mbar) | 5.5 (mbar) |
| 5.6 (mbar) | 6.3 (mbar) | 5.8 (mbar) |

TABLE 7
(Tests with regard to repellency to alcohol and oil)
(PP nonwoven 20 g/m²)
20 g/m² PP non woven

| | Alcohol repellency | Oil repellency |
|---|---|---|
| | test to | test to DIN |
| Nonwoven sample | IST 80.1 (01) | EN ISO 14419 |
| firstly coated with SiO₂, | 10 | 8 |
| then 17 g/l FC | (very good) | (very good) |
| firstly coated with | 10 | 8 |
| SiO₂/Al₂O₃, then 17 g/l | (very good) | (very good) |
| FC | | |
| coated only with 17 g/l | 6 | 1 |
| FC | | (very poor) |

Note:
the two-step method according to the invention was applied.

TABLE 8
(Measurement of the water column with the water tightness test
apparatus TEXTEST)
(52 g/m² PP nonwoven)

| | | | firstly coated with | | | | | |
|---|---|---|---|---|---|---|---|---|
| firstly coated with SiO₂, | | | SiO₂/Al₂O₃, then 17 g/l | | | coated only with 17 g/l | | |
| then 17 g/l FC | | | FC | | | FC | | |
| 1. Tr. | 2. Tr. | 3. Tr. | 1. Tr. | 2. Tr. | 3. Tr. | 1. Tr. | 2. Tr. | 3. Tr. |
| [mbar] | [mbar] | [mbar] | [mbar] | [mbar] | [mbar] | [mbar] | [mbar] | [mbar] |
| 35.0 | 36.5 | 37.0 | 18.0 | 20.5 | 22.5 | 12.0 | 12.5 | 40.5 |
| <17 | <17 | <17 | 20.0 | 23.5 | 23.5 | 12.0 | 12.0 | 16.0 |
| 30.0 | 32.0 | 35.0 | 22.0 | 24.5 | 24.5 | 41.5 | 59.0 | 68.0 |
| <28 | <28 | <28 | 18.0 | 24.5 | 24.5 | 53.0 | 55.0 | 64.5 |
| 40.0 | 41.5 | 41.5 | 23.5 | 23.0 | 23.0 | 53.0 | 60.0 | 66.0 |
| 33.5 | 34.0 | 36.0 | 21.0 | 22.0 | 22.0 | 57.0 | 70.5 | 74.0 |

| | | |
|---|---|---|
| 37.6 | 23.3 | 54.8 |

TABLE 9
(Tests with regard to alcohol and oil repellency)
(PP nonwoven 52 g/m²)

| | Alcohol repellency | Oil repellency |
|---|---|---|
| | test to | test to DIN |
| Nonwoven sample | IST 80.1 (01) | EN ISO 14419 |
| firstly coated with SiO₂, | 10 | 8 |
| then 17 g/l FC | (very good) | (very good) |
| firstly coated with | 10 | 8 |
| SiO₂/Al₂O₃, then 17 g/l | (very good) | (very good) |
| FC | | |
| coated only with 17 g/l | 2 | 1 |
| FC | (very poor) | (very poor) |

Note:
treated by the two-step method according to the invention

TABLE 10
(Influence of the particle sizes on textile materials)
(Test of the effects on repellency to water, oil and alcohol)

| | PP nonwoven (52 g/m²) | | | | PES woven fabric (106 g/m²) | | | |
|---|---|---|---|---|---|---|---|---|
| | Firstly coated with nanoscale particles, then | | | | Firstly coated with nanoscale particles, then | | | |
| | 17 g/l FC | | | | 10 g/l FC | | | |
| Test | 10 nm | 147 nm | 118 nm | 2700 nm* | 10 nm | 147 nm | 118 nm | 2700 nm* |
| specification | SiO₂ | SiO₂ | SiO₂/Al₂O₃ | SiO₂/Al₂O₃ | SiO₂ | SiO₂ | SiO₂/Al₂O₃ | SiO₂/Al₂O₃ |
| Water | 4 | 5 | 5 | 4-5 | 2 | 4 | 5 | 5 |
| repellency | good | very good | very good | good | poor | good | very good | very good |
| to DIN EN | | | | | | | | |
| 24920 | | | | | | | | |
| Alcohol | 2 | 10 | 10 | 1 | 5 | 8-9 | 10 | 9 |
| repellency | poor | very good | very good | very poor | adequate | good | very good | good |
| to IST 80.1 | | | | | | | | |
| (01) | | | | | | | | |
| Oil | 1 | 8 | 8 | 1 | 2-3 | 6-7 | 8 | 6-7 |
| repellency | very poor | very good | very good | very poor | poor | good | very good | good |
| to DIN EN | | | | | | | | |
| ISO 14419 | | | | | | | | |

*hard feel on textiles

### Captions

### FIG. 1

1% by weight TMOS; 20 mol % Al₂(SO₄)₃ and one drop of dispersing agent (20° C.; 120 h; glass carrier)

### (Dependency of the Particle Size on the Concentration of the Dispersion)

### FIG. 2

### (Investigation by Means of AFM)

tiefe Löcher=deep holes
Nanopartikel=nanoparticles

1. (cancel)

2. (cancel)

3. (cancel)

4. (cancel)

5. (cancel)

6. (cancel)

7. (cancel)

8. (cancel)

9. (cancel)

10. (cancel)

11. (cancel)

12. (cancel)

13. (cancel)

14. (cancel)

15. (cancel)

16. (cancel)

17. (cancel)

18. (cancel)

19. (cancel)

20. (cancel)

21. (cancel)

22. (cancel)

23. (cancel)

24. (cancel)

25. (cancel)

26. (cancel)

27. (cancel)

28. (cancel)

29. (cancel)

30. (cancel)

31. (cancel)

32. (cancel)

33. (cancel)

34. (cancel)

35. A liquid medium with a content of nanoscale primary particles dispersed therein based on SiO₂ or a mixed oxide of SiO₂ and other metal oxides, especially Al₂O₃, characterised in that the nanoscale primary particles have a mean particle size of 1 to 2000 nm (determined by the method of measuring the particle size with the Zetasizer NS apparatus (Nano Series)) as well as a negative charge, measured as the zeta potential (determined by the measuring method as a function of the pH with the Zetasizer apparatus) and are present in situ in the liquid medium.

36. A liquid medium according to claim 35, characterised in that the liquid medium is the reaction medium, in which the nanoscale primary particles have been formed.

37. A liquid medium according to claim 35, characterised in that the liquid constituent is based on water and/or alcohol.

38. A liquid medium according to claim 35, characterised in that the nanoscale primary particles have a mean particle size of about 40 to 500 nm.

39. A liquid medium according to claim 35, characterised in that it contains nanoscale primary particles based on a mixed oxide in the form of SiO₂/Al₂O₃, and the zeta potential is about −8 to −100 mV.

40. A liquid medium according to claim 35, characterised in that it contains nanoscale primary particles based on SiO₂, which have a zeta potential of about −100 to −200 mV.

41. A liquid medium according to claim 35, characterised in that the nanoscale primary particles are present in the form of a mixed oxide of SiO₂ and other metal oxides, about 0.125 to 0.625 parts by weight, especially about 0.125 to 0.25 parts by weight of the further metal oxide being apportioned to one part by weight SiO₂.

42. A method for producing a liquid medium with a content of nanoscale primary particles dispersed therein according to at least any one of the preceding claims, characterised in that an aqueous dispersion of an orthosilicate is stirred in the presence of a dispersing agent with a high-power stirrer and the orthosilicate is hydrolysed into nanoscale primary particles or the dispersion of a metal salt is mixed into the dispersion of the orthosilicate to form a mixed oxide of SiO₂ and other metal oxides and this dispersion is stirred with a high-power stirrer and the orthosilicate contained therein is hydrolysed into nanoscale primary particles.

43. A method according to claim 42, characterised in that the concentration of the orthosilicate in the respective dispersion is adjusted to about 0.5 to 5% by weight, especially to about 0.5 to 2% by weight.

44. Use of the liquid medium with a content of nanoscale primary particles dispersed therein according to claim 42 for the hydrophilising coating of hydrophobic textile materials.

45. Use according to claim 42, characterised in that, as textile materials, filaments, fibres, yarns, woven fabrics, knitted fabrics and/or nonwovens are provided with a hydrophilic coating.

46. Use according to claim 42, characterised in that the textile materials comprise of organic polymers or glass materials.

47. Use according to claim 42 with the obtaining of textile materials with strongly pronounced hydrophilic properties, determined by the measuring method of the contact angle of a water drop and the liquid strike through time test.

48. Use according to claim 42, characterised in that the degree of hydrophilisation, measured on a polypropylene nonwoven, is expressed in that the contact angle of a water drop in comparison to the non-hydrophilised polypropylene nonwoven is reduced from 120 to 60° and in polypropylene woven fabrics from 117 to 48°.

49. Use according to claim 42, characterised in that the degree of hydrophilisation, measured on a polypropylene nonwoven, is expressed in that in a liquid strike through time test, the hydrophilised polypropylene nonwoven is wetted with the test liquid in less than 3 seconds.

50. Use according to claim 42, characterised in that a hydrophobic outer layer with improved alcohol and oil repellency in comparison to a textile material without a hydrophilic intermediate layer is formed on the hydrophilic coating of the textile materials.

51. Use according to claim 42, characterised in that to form the hydrophobic outer layer, fluorinated compounds, especially fluorocarbon resins are used, especially in a significantly reduced application quantity compared to a textile material without a hydrophilic intermediate layer without the alcohol and oil repellency aimed for being impaired.

52. Use according to claim 42, characterised in that an antimicrobial finish, especially an antibactericidal finish is implemented on the hydrophilic coating of the textile materials.
